(19) United States
(12) Patent Application Publication
(10) Pub. No.: US 2023/0073893 A1
(43) Pub. Date: Mar. 9, 2023

(54) LONG SHORT TERM MEMORY (LSTM) LAYER HARDWARE ACCELERATION

(71) Applicant: XILINX, INC., San Jose, CA (US)

(72) Inventors: Karri Manikantta REDDY, Hyderabad (IN); Akshay JAIN, Bijnor (IN); Keshava Gopal Goud CHERUKU, Hyderabad (IN)

(21) Appl. No.: 17/468,350

(22) Filed: Sep. 7, 2021

(51) Int. Cl. G06F 17/16

(52) U.S. Cl. CPC G06F 17/16

(57) ABSTRACT

Method for accelerating matrix vector multiplication (MVM), long short-term memory (LSTM) systems and integrated circuits for the same are described herein. In one example, a system for accelerating processing by an LSTM architecture includes a first processing circuitry (FPC) and a second processing circuitry (SPC). The FPC receives weight matrices from a trained neural network, and stores the weight matrices in a first memory circuitry. The SPC stores the weight matrices in a second memory circuitry, and generates an output vector based on the weight matrices and input vectors. The FPC further processes each of the weight matrices for communication to the SPC, and divides each weight matrix into a number of tiles based on an available resources in the second memory circuitry and a size of the weight matrix. The SPC further applies each tile of each weight matrix to a corresponding input vector to generate the output vector.

### TECHNICAL FIELD

Various embodiments described herein relate to hardware accelerations, and more specifically, to a hardware accelerator architecture for use in a neural network cell.

### BACKGROUND

A recurrent neural network (RNN) architecture is a type of neural network architecture where an output from a previous step is fed as an input to a current step. A long short-term memory (LSTM) is a more complex type of RNN architecture capable of processing single data points as well as sequences of data, providing state-of-the-art accuracies for applications such as speech recognition, sentiment analysis, machine translation, and the like. The LSTM architecture of the RNN includes one or more LSTM layers. Each LSTM layer of the LSTM architecture may include a plurality of LSTM cells, where each LSTM cell in the LSTM layer takes the output of the preceding cell as an input to the current cell. Each LSTM cell may include a set of neurons and computes four intermediate results, called gates. These gates include a forget gate, fₜ, an input gate, iₜ, an output gate, oₜ, and a candidate gate, gₜ. The forget gate, fₜ, controls whether to erase data from a cell-state for a particular LSTM cell; the input gate, iₜ, controls whether to write data to the cell-state for the LSTM cell; the output gate, oₜ, controls what data to pass as an output of the cell-state for the LSTM cell; and the candidate gate, gₜ controls what data to write to the cell state for the LSTM cell.

In operation, a current LSTM cell of the LSTM layer takes an internally stored hidden state vector hₜ₋₁ and a memory cell vector cₜ₋₁ from the preceding LSTM cell along with an input vector xₜ for the current cell. When there are T total input vectors xₜ, such that 1≤t≤T, then the corresponding LSTM layer has T LSTM cells or one LSTM cell that processes the input vectors xₜ in T iterations. If the LSTM layer process the inputs from x₁ to x_{T}, then the LSTM layer is a forward LSTM layer; if the LSTM layer processes the inputs from x_{T} to x₁, then the LSTM layer is a backward LSTM layer. A Bi-LSTM layer produces both forward and backward hidden state vectors hₜ at each LSTM cell, subsequently adding/concatenating the hₜ of corresponding LSTM cells in forward and backward LSTM layers.

The LSTM cell having n hidden nodes or neurons and receiving m dimensional inputs or input nodes may employ various matrix-vector multiplication (MVM) operations to generate a corresponding output vector. For example, if performed in a linear, non-parallel manner, the MVM operation may have a latency of O(n×m). Hardware accelerators may be employed for MVM operations to enable parallel computations to increase processing speeds, for example, by utilizing “n” parallel multiply accumulate (MAC) units. Such acceleration may reduce MVM operation latencies to O(m), which is linear in time. However, in integrated circuit (IC) embodiments, such hardware accelerators may provide limited benefits for large values of m and n (for example, greater than 512 values) because the parallelization itself is limited by the available resources.

In LSTM neural network applications involving a large number of neurons, certain hardware acceleration options that utilize smaller numbers of neuron n and input vector size or dimension m are unavailable due to the limited IC resources. Other hardware acceleration options that employ a fixed number of parallel multipliers to perform each MVM operation with multiple iterations may not benefit from excess IC resources. Such hardware acceleration may not benefit from excess IC resources where the number of parallel multipliers are fixed because the design takes the same number of iterations regardless of different amounts of available resources on the IC.

Thus, improved systems, methods, and apparatuses of reducing LSTM latencies to benefit from the resources available in an IC are desirable and further accelerate LSTM RNN network processing.

### SUMMARY

Method for accelerating matrix vector multiplication (MVM), long short-term memory (LSTM) systems and integrated circuits for the same are described herein. In one example, a method for accelerating MVM includes creating a number of tiles for each weight matrix of a plurality of weight matrices based on a size of the weight matrix and an amount of on-chip memory available, the plurality of weight matrices comprising a set of recurrent weight matrices and a set of non-recurrent weight matrices; for each non-recurrent weight matrix of the set of non-recurrent weight matrices, processing each tile of the number of tiles of the non-recurrent weight matrix based on: multiplying each tile of the number of tiles for the non-recurrent weight matrix by each input vector of a set of non-recurrent input vectors based on loading the tile into an on-chip memory, and applying the tile to each input vector of the set of non-recurrent input vectors before loading a subsequent tile of the number of tiles. For each recurrent weight matrix of the set of recurrent weight matrices, processing each tile of the number of tiles of the recurrent weight matrix based on: multiplying each recurrent input vector of a set of recurrent input vectors by each tile of the number of tiles for the recurrent weight matrix based on sequentially loading the tile into the on-chip memory, and sequentially applying the tile to a first recurrent input vector of the set of recurrent input vectors before sequentially loading and applying the tile to a subsequent recurrent input vector of the set of recurrent input vectors. The method also includes generating an output based on the processing of the tiles of the set of non-recurrent weight matrices and the processing of the tiles of the set of recurrent weight matrices.

In another example, an integrated circuitry is provided that includes a processing system and a programmable logic. The processing system includes a processing circuitry and a memory circuitry. The processing system is configured to create a number of tiles for each weight matrix of a plurality of weight matrices based on a size of the weight matrix and an amount of on-chip memory available. The plurality of weight matrices includes a set of recurrent weight matrices and a set of non-recurrent weight matrices. The programmable logic includes a signal processor and an on-chip memory circuitry. The programmable logic is configured to, for each non-recurrent weight matrix, process each tile of the number of tiles of the non-recurrent weight matrix based on: multiplication of each tile of the number of tiles for the non-recurrent weight matrix by each input vector of a set of non-recurrent input vectors based on loading the tile into the on-chip memory, and application of the tile to each input vector of the set of non-recurrent input vectors before loading a subsequent tile of the number of tiles. The programmable logic is configured to, for each recurrent weight matrix, process each tile of the number of tiles of the recurrent weight matrix based on: multiplication each recurrent input vector of a set of recurrent input vectors by each tile of the number of tiles for the recurrent weight matrix based on sequentially loading each tile into the on-chip memory and sequentially applying each tile to a first recurrent input vector of the set of recurrent input vectors before sequentially loading, and application of each tile to a subsequent recurrent input vector of the set of recurrent input vectors. The programmable logic is also configured to generate an output based on the processing of the tiles of the set of non-recurrent weight matrices and the processing of the tiles of the set of recurrent weight matrices.

In yet another example, a system for accelerating processing by an LSTM architecture is provided that includes a first processing circuitry and a second processing circuitry. The first processing circuitry is configured to: receive a plurality of weight matrices from a trained neural network, and store the plurality of weight matrices in a first memory circuitry. The second processing circuitry is configured to: store the plurality of weight matrices in a second memory circuitry, and generate an output vector based on the plurality of weight matrices and a plurality of input vectors. The first processing circuitry is further configured to: process each of the plurality of weight matrices for communication to the second processing circuitry, and divide each weight matrix of the plurality of weight matrices into a number of tiles based on an available resources in the second memory circuitry and a size of the weight matrix. The second processing circuitry is further configured to apply each tile of each weight matrix to a corresponding input vector of the plurality of input vectors to generate the output vector.

### BRIEF DESCRIPTION OF DRAWINGS

So that the manner in which the features recited above can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 depicts an IC architecture comprising a processing system (PS) in communication with a programmable logic (PL), according to an exemplary embodiment.

FIG. 2 depicts an exemplary block diagram of interconnects between a memory circuitry and a random access memory (RAM) of the IC, according to an exemplary embodiment.

FIG. 3 depicts an example block diagram of a matrix multiplication circuitry configured to apply weight matrices W_{#} and U_{#} to input vectors (xₜ) and (hₜ₋₁), respectively, to generate an output vector, according to an exemplary embodiment.

FIG. 4 depicts an exemplary block diagram of depicting the transfer of output vectors from a RAM to a memory circuitry via interconnects, according to an exemplary embodiment.

FIG. 5 depicts an LSTM architecture that performs operations described herein, according to an exemplary embodiment.

FIG. 6 depicts a flowchart for operations that calculate output vectors for MVM operations when applying optimizations described herein, according to an exemplary embodiment.

FIG. 7A is a block diagram depicting a programmable IC according to an example.

FIG. 7B illustrates a field programmable gate array (FPGA) implementation of a programmable IC according to an example.

FIG. 7C is a block diagram depicting a multi-integrated circuit (IC) programmable device according to an example.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the features or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Recurrent neural network (RNNs) are neural networks that employ an output from a previous step as an input to a current step. Long Short-Term Memory (LSTM) architectures show state-of-the-art accuracies that are well-suited to classifying, processing, and making predictions based on time series data. As such, LSTM architectures can be used in applications such as speech recognition, sentiment analysis, machine translation, weather, traffic, stock market predictions, handwriting recognition, human action recognition, text summarization, music generation, and so forth. LSTM layers comprise LSTM cells, where each LSTM cell takes the output of the preceding cell as one of the inputs to the current cell. Each LSTM cell computes a forget gate, fₜ, an input gate, iₜ, an output gate, oₜ, and a candidate gate gₜ based on an internally stored hidden state vector hₜ₋₁ and a memory cell vector cₜ₋₁ (both from a preceding LSTM cell) as well as an input vector xₜ as inputs to the LSTM cell. The following mathematical equations (1)-(6) describe how the gate values and output values for the current LSTM cell are determined.

fₜ=σ(W_{f}*xₜ+U_{f}*hₜ₋₁+b_{f}) (1)

iₜ=σ(Wᵢ*xₜ+Uᵢ*hₜ₋₁+bᵢ) (2)

oₜ=σ(Wₒ*xₜ+Uᵢ*hₜ₋₁+bₒ) (3)

gtₜ=Tan h(W_{g}*xₜ+U_{g}*hₜ₋₁b_{g}) (4)

cₜ=fₜ∘cₜ₋₁+iₜ∘gₜ (5)

hₜ=oₜ∘ Tan h(cₜ) (6)

Where W_{#}, U_{#}, and b_{#} (#=i,f,g,o) are trained model coefficients for each gate, generally represented as matrices. The results of these gates, per equations (1)-(4), can subsequently be used to compute the memory cell outputs cₜ and hₜ through a series of element-wise multiplications. In the equations (1)-(6) above, “*” denotes matrix multiplication and “∘” denotes element-wise multiplication. The σ and Tan h in equations (1)-(4) represent non-linear functions sigmoid and hyperbolic tangent, respectively, depicted by equations (7) and (8) below:

$$σ ( p ) = \frac{1}{1 + {e}^{- p}} \qquad ( 7 )$$

$$Tanh ( p ) = \frac{{e}^{p} - {e}^{- p}}{{e}^{p} + {e}^{- p}} \qquad ( 8 )$$

When there are T total input vectors xₜ, such that 1≤t≤T, then an LSTM layer may comprise T LSTM cells or one LSTM cell processing corresponding input vectors in T iterations.

Where the LSTM cell has n neurons and takes a m dimensional input vector, then corresponding weight matrices W_{#} may have a size of n×m, and weight matrices U_{#} may have a size of n×n. Bias vectors and all other output vectors in equations (1)-(6) have a size of n×1. The eight matrix-vector multiplications (W_{#}*xₜ and U_{#}*hₜ₋₁) in equations (1)-(4) contribute to the overall time taken for processing the corresponding LSTM cell. For example, these eight matrix-vector multiplications may contribute to more than 90% of the processing of the corresponding LSTM cell(s). Matrix-vector multiplication (MVM) of a matrix Wᵢ of the size n×m by a vector xₜ of size m×1 produces an output vector Wᵢₓ of size n×1. When performed in a linear, non-parallel manner, the MVM operation Wᵢ*xₜ uses a single multiplier for the operation and has a latency of O(n×m). A hardware accelerator for such MVM operation may compute every element of the output vector Wᵢₓ in parallel with “n” parallel multiply accumulate (MAC) units in the hardware accelerator. By this approach, the latency of the MVM operations may be reduced to O(m), which is linear in time. However, while this hardware accelerator reduces the latency of the MVM operations, such an accelerator may not work for large values of m and n because parallelization is limited based on available resources of a corresponding integrated circuit (IC).

In some embodiments, a hardware accelerator applied to a LSTM architecture limits LSTM cell m and n sizes so that the resources on the IC are sufficient to store corresponding weight matrices and perform MVM operations using multiple parallel multipliers, thereby reducing latencies, as introduced above. However, this hardware accelerator may not be applicable for complex neural network applications that employ LSTM architectures with a large number of neurons, due to the limited IC resources.

In certain other embodiments, the LSTM hardware accelerator may employ a fixed number of parallel multipliers and correspondingly utilize fixed resources on the IC by performing the MVM operation in multiple iterations. Such accelerators take multiple iterations to perform each MVM operation and have computation latencies of O(m×iterations) for each W_{#}*xₜ and O(n×iterations) for each U_{#}*hₜ. However, because the number of parallel multipliers is fixed in these accelerators, such accelerators use the same number of iterations for ICs regardless of the resources available on the ICs. However, from equations (1)-(6), it can be observed that the operation of t^{th} LSTM cell cannot begin until the vectors hₜ₋₁ and cₜ₋₁ from the (t−1)^{th} LSTM cell are available. More explicitly, no LSTM cell can begin MVM operations until the output vectors from the preceding LSTM cell(s) are computed. Therefore, if an on-chip memory for the IC is insufficient to process a number of MVM operations (for example, the eight MVM operations introduced for equations (1)-(6) above) in one iteration, then the same weight matrices are reloaded into the on-chip memory to be processed by every LSTM cell, resulting in loading or writing latencies for each LSTM cell corresponding to the same weight data. As such, the recurrent dependency in LSTM makes the data communication latency, for example, between a processing system (PS) and a programmable logic (PL) of an IC such as a field-programmable gate array (FPGA) a significant bottleneck in iterative processing as introduced in the second method.

Systems, methods, and apparatuses described herein introduce aspects of a hardware accelerator for an LSTM architecture that increase speeds of operation of an LSTM cell implemented on or via an IC. The LSTM architecture aspects and optimizations disclosed enable flexible solutions that accommodate neural networks of various dimensions and sizes (small and large) with as few iterations as possible while performing each MVM operation. Moreover, the aspects described herein ensure that the available resources of the IC are employed, for example, to reduce a number of iterations as much as possible on account of available resources. The aspects utilize the MAC units arranged to realize the parallel operation of the MVM operations in equations (1)-(4) while applying various algorithm-hardware co-optimizations. Such co-optimizations to this processing include rearranging and formatting the weight matrices W_{#} and U_{#} in the PS to improve speeds of transfer of the weights between the PS and the PL, maximizing bandwidth usage during the transmissions between the PS and the PL, and optimizing processing of the MVM operations to reduce data communication latencies while accounting for availability of resources, among other benefits.

Furthermore, the aspects described herein provide a flexible design that can be adjusted based on resources available on the IC, limits on resource utilization on the IC, differences between ICs, and different values of input and hidden state vectors. More specifically, the aspects described herein introduce a parametrized hardware accelerator for an LSTM architecture that accommodates networks of various sizes into an IC. If a LSTM architecture with different parameters (m and n) is employed on an IC having a specific or different amount of available resources, the aspects described herein can be adjusted to accommodate the respective input parameter before a synthesis stage. In some embodiments, the synthesis stage refers to generation of a bitstream, which can be used to program a programmable logic of an IC, such as an FPGA). When m and/or n changes, the synthesis stage may generate a different bitstream, which is used to program the IC.

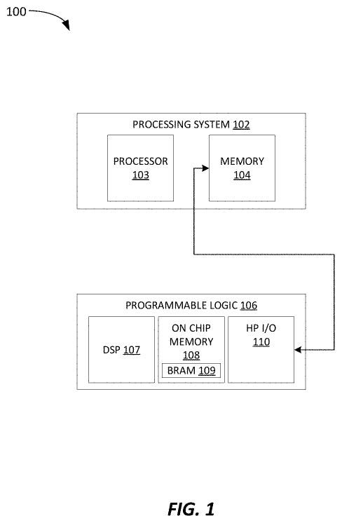

FIG. 1 depicts the architecture of an IC 100 comprising a processing system (PS) 102 in communication with a programmable logic (PL) 106, where the PS 102 and the PL 106 are configured to implement one or more features described herein, according to an exemplary embodiment.

The PS 102 comprises a hardware processor circuitry 103 and a memory circuitry 104. The hardware processor circuitry 103 may correspond to an application processing unit (APU) or a central processing unit (CPU). In some embodiments, the memory circuitry 104 comprises a double data rate (DDR) memory and has a size of, for example, 4 GB. In some embodiments, though not shown explicitly in FIG. 1, the PS 102 further comprises a graphics processing unit and an input/output interface. The PS 102 may write the re-arranged weights into the memory circuitry 104, and a finite state machine (FSM) running on the PL 106 may coordinate control signals to transfer data to and/or from the memory circuitry 104, tile the weight matrices, perform MAC operations, and so forth. For example, the PS 102 enables the PL 106 to use the FSM to generate signals to perform different steps of the LSTM architecture, as described herein, before the PL 106 provides control back to the PS 102. Further details are provided below.

The PL 106 comprises an on-chip memory circuitry (on-chip memory) 108 that comprises a RAM (random access memory) or similar memory (read only memory (ROM), etc.) circuitry 109, which represents multiple individual RAM blocks (or similar memory blocks, also referred to herein as RAMs) capable of storing data, as discussed in further detail below. The PL 106 may further comprise a digital signal processor (DSP) 107 configured to perform mathematical operations, such as multiplication and addition, on data stored in the on-chip memory 108. The PL 106 further comprises high performance input/output (HP I/O) 110 ports that enable the communication of data between the memory circuitry 104 of the PS 102 and the on-chip memory 108 (for example, the RAM circuitry 109) of the PL 106. In some embodiments, data stored in the memory circuitry 104 can be communicated to the on-chip memory 108 of the PL 106 via the HP I/O 110 for processing by the DSP 107, and vice versa. The data transferred to the on-chip memory 108 may comprise weights applied to elements in input vectors. The data transferred to the memory circuitry 104 includes outputs generated based on solving equations (1)-(6) above.

In some embodiments, for deep learning applications employing the RNN architectures described herein, the LSTM architecture may utilize a number of inputs “m” and hidden nodes “n” with numbers between, for example, 512 and 2048. If the number of input nodes “m” and hidden nodes “n” is equal to 1024, each weight matrix, as introduced above, has a size of 1024×1024. Thus, storage of each weight matrix would require a total of 1024*1024*number of bits corresponding to the precision of weights (for example, 1 Megabit (Mb) for 1-bit weights, 32-Megabits for 32-bit weights). With eight MVMs storing weights at a float32 precision, 256 Mb (1 Mb*32 bits*8 weight matrices) of space in the RAM circuitry 109 is needed to store all of the corresponding weight matrices.

In embodiments where the on-chip memory 108 has a size of between 3.8 Mb and 34.6 Mb, the weight matrices 256 Mb cannot be stored directly onto the on-chip memory 108 from the memory circuitry 104. Instead, weight tiling introduced below can be used to transfer the 256 Mb worth of weight matrices between the memory circuitry 104 and the on-chip memory 108. For example, assuming that the RAM circuitry 109 has a size of 4 Mb, 64 iterations would transfer the 256 Mb of weight matrices to the on-chip memory 108.

The HP I/O 110 may include any number of ports and may be configured to transfer data between the memory circuitry 104 and the RAM circuitry 109 via corresponding interconnects. By employing more than one port, communication latencies between the memory circuitry 104 and the RAM circuitry 109 can be reduced. In some embodiments, the HP I/O 110 comprises four ports that enable communications between the memory circuitry 104 and the RAM circuitry 109, each port having a bandwidth of 128-bits. Thus, in this example, the entire bandwidth of the HP I/O 110 is 512-bits (4 ports*128-bits per port). In some embodiments, the 128-bit port width enables each port to handle four float32 size precision values. In some embodiments, the HP I/O 110 includes a different number of ports (more or fewer than four ports) or the ports of the HP I/O 110 may have a different size or width (greater or less than 128-bits), for example, to operate or be implemented with different precision values, such as int16, int8, and so forth. In some embodiments, with int16 precision values, eight data values can be packed to use the maximum bandwidth of the 128-bit port.

To fully utilize the bandwidth provided by the HP I/O 110 ports for data transfers between the memory circuitry 104 and the RAM circuitry 109, the HP I/O 110 ports are fully packed for each data transfer, meaning that each bit of the HP I/O 110 ports is used to transfer data. Using each HP I/O 110 port to transfer four float32 values per cycle (4*32-bits=128-bits) will result in fully packing the HP I/O 110 port. Where the HP I/O 110 includes the four ports, each cycle of data transfer between the memory circuitry 104 and the RAM circuitry 109 transfers sixteen float32 values when maximizing data transfer bandwidth (i.e., when fully packed) with careful orchestration of RAMs, where the sixteen weights transfer to sixteen different RAMs.

Furthermore, both input and output vectors are transferred by packing a number of elements (for example, float32 values that transfer 128 bits in the examples described herein) in each clock cycle with careful orchestration of RAMs of the RAM circuitry 109, where the inputs transfer to different RAMs and the outputs transfer from different RAMs of the RAM circuitry 109.

Maximizing the data transfer bandwidth may employ the writing of the sixteen different float32 values into sixteen different destination RAMs of the RAM circuitry 109, where each destination RAM accepts one data value per clock cycle. Additional HP I/O 110 ports and larger port sizes (for example, greater than 128-bit ports) may enable greater data transfer bandwidths, assuming a sufficient number of RAMs are available to accept the transferred data and that the memory circuitry 104 is able to provided data at the greater data transfer bandwidths. On the other hand, fewer HP I/O 110 ports or smaller port sizes would result in lower data transfer bandwidths. Based on constraints such as available RAMs, number of ports, port bandwidths, and the like, maximizing data transfer between the memory circuitry 104 and the RAM circuitry 109 may benefit from data organization as described below.

The RAM circuitry 109 may be sized to store a given amount of data, such as 36 kilobits (Kb) of data, and be configured as one or more blocks of RAM. For example, when the RAM circuitry 109 is sized to store 36 Kb, the RAM circuitry 109 may be organized into a single 36 Kb block, two 18 Kb blocks, four 9 Kb blocks, and so forth. When the RAM circuitry 109 is organized into the two 18 Kb blocks, each 18 Kb block may comprise 1024 memory elements each having a size of 18-bits. The RAM circuitry 109, as discussed with reference to the 36 Kb example, may have any size that is larger or smaller than the 36 Kb example discussed herein. For example, larger capacity RAM circuitries 109 may comprise multiple 36 Kb or smaller blocks to create the desired larger capacity. In the example described herein with the float32 values, each memory element has a size of 36-bits, where 32-bits are used to store the float32 value and 4-bits are unused. Thus, each 36-bit memory element may store a float32 value unpacked from the data received for an HP I/O port, such that four 36-bit memory elements are used to unpack the 128-bits of the four float32 values from each HP I/O port described above.

In some embodiments, a memory block is declared to store Max{M,N} elements since each of the weight matrices W_{#} and U_{#} have M and N elements, respectively, in each row after zero padding. Thus, each memory block may store an entire row of the weight matrices. In non-recurrent MVM operations, there are M elements in each row and in recurrent MVM operation, there are N elements in each row. Where the same hardware processes both the non-recurrent and recurrent operations, as described in further detail herein, each memory block should be declared to have sufficient capability to store Max{M,N} values and, thus, fit the entire row of the weight matrices. If Max{M,N} is less than 1024-bits, then each memory block requires 1 memory element. Otherwise, each RAM block requires multiple memory elements, (because 1 RAM=1024*36-bits)

Similarly, the input vectors xₜ and hₜ₋₁ also have M and N elements, respectively, after the zero padding. Thus, the four input RAMs, in combination, can store Max {M, N} elements, as well.

In some embodiments, the numbers of elements, weights, and the like, described herein are specific to the example arrangement of the memory circuitry 104 coupled to the RAM circuitry 109, namely the four HP I/O 110 ports, the 128-bit bandwidth for each port, and so forth. As such, the described embodiments, for each weight matrix, transfer elements from four different rows of the weight matrix corresponding to the float32 size and the 128-bit bandwidth. Different value precisions, different sized bandwidths, or different numbers of ports may result in the data transfer of different numbers of elements from different numbers of rows, and so forth.

### Weight Rearrangement

As introduced above, copying the weight matrices from the memory circuitry 104 to the RAM circuitry 109 comprises transferring individual rows of the W_{#} or U_{#} weight matrices into a dedicated RAM block of the RAM circuitry 109. To utilize the full 128-bit data width of each of the four HP I/O 110 ports, four weight values (each having a size of 32-bits) from four different rows of the W_{#} or U_{#} weight matrix that is currently being transferred are transferred from the memory circuitry 104 to the RAM circuitry 109 in a given data cycle.

Furthermore, the weight matrices W_{#} and U_{#} can be stored in a corresponding transfer order in continuous locations in the memory circuitry 104. This can benefit from burst transfer capabilities of the memory circuitry 104 (for example, when the memory circuitry 104 comprises the DDR memory) and avoid pre-packing the four values into a 128-bit structure before the data transfer between the memory circuitry 104 and the RAM circuitry 109 begins, which takes additional resources and time. Accordingly, each of the W_{#} and U_{#} weight matrices is arranged and stored in the memory circuitry 104 in, for example, a column major order. As such, weights data from four consecutive rows of the weight matrix will be placed into four consecutive address locations of the memory circuitry 104.

The weights of the W_{#} and U_{#} weight matrices are provided by a trained NN model and stored in either column major order or row major order. When not provided in column major order, the W_{#} and U_{#} weight matrices need to be transposed into the column major order before or while being written into the memory circuitry 104. The transposing of the weights into the column major order may occur offline (e.g., when data is not being transferred between the memory circuitry 104 and the RAM circuitry 109 and before processing of the LSTM).

Based on the transfer from four different rows in the weight matrices, the number of rows, m, of each weight matrix W_{#} and U_{#} should be a multiple of four to ensure that each data transfer includes four elements from four different rows. Should the number of rows not be a multiple of four, then one or more rows are padded with zeroes such that the total number of rows for the weight matrix is a multiple of four. The weight matrix (padded or not) is then transposed. The number of rows m that is a multiple of four, either before padding or including padding, is denoted as M. Similarly, the number of rows, n, of each weight matrix W_{#} and U_{#} should be a multiple of four to ensure that each data transfer includes four elements from four different rows. Should the number of rows not be a multiple of four, then one or more rows are padded with zeroes such that the total number of rows for the weight matrix is a multiple of four. The weight matrix (padded or not) is then transposed. The number of rows n that is a multiple of four, either before padding or including padding, is denoted as N. In some embodiments, the padding makes the number of rows evenly divisible by the ratio of a bit-width of the HP I/O port and a weight precision of the weights in the weight matrices W_{#} and U_{#}. For example, if the HP I/O port bit-width is 128-bits and the weight precision is float32, then the number of rows needs to be divisible by 128/32=4, so the weight matrix is padded until the number of rows is divisible by 4. Similarly, if the HP I/O port bit-width is 128-bits and the weight precision is int16, then the number of rows needs to be divisible by 128/16=8, and for the weight precision of int8, the number of rows needs to be divisible by 128/8=16, and so forth.

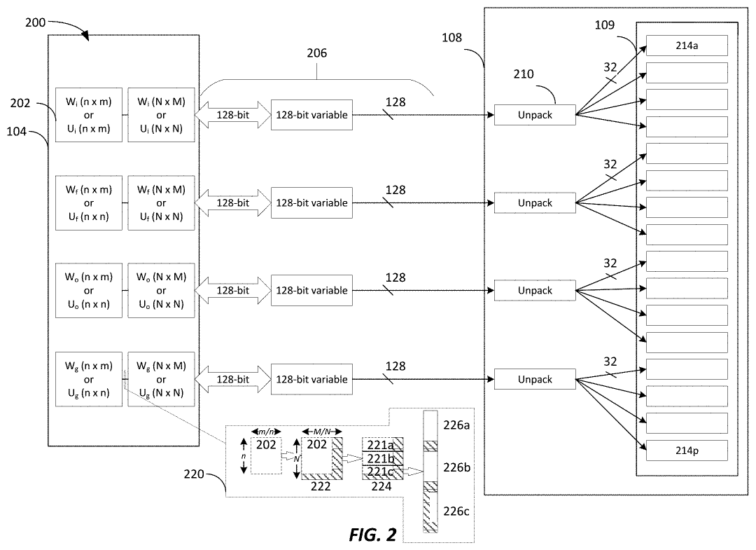

In some embodiments, rearranging weights from the weight matrices W_{#} and U_{#} for transfer from the memory circuitry 104 to the on-chip memory 108 improves transfer times and data latencies. The memory circuitry 104 may benefit from specific arrangements of data. FIG. 2, which describes the transfer of the data between the memory circuitry 104 and the RAM circuitry 109, provides details of such rearrangement.

FIG. 2 depicts an exemplary block diagram 200 of interconnects between the memory circuitry 104 and the RAM circuitry 109 of the IC 100. Specifically, the diagram 200 shows representations of the weight matrices W or U 202 having sizes of (m×n) or (n×n), respectively, stored in the memory circuitry 104. In some embodiments, the weight matrices 202 are yet to be transposed. As shown in an inset 220, the weight matrices 202 are padded and transposed to generate the sizes (M×N) or (N×N) to employ the burst transfer capabilities of the memory circuitry 104.

As shown in the inset 220, the weight matrices 202 are tiled, padded, and transposed by, for example, the PS 102. Specifically, in the inset 220, the weight matrix 202, having the size (m×n), is padded to give it the size (M×N) and tiled into a number of tiles 221a-221c, as described herein.

As shown in the inset 220, the weight matrix 202 is padded in both the m and n directions, generating a padded weight matrix 222 having the size (M×N). The padded weight matrix 222 includes a shaded region corresponding to padding added to the weight matrix 202 in both horizontal and vertical directions.

### Tiling

Tiling divides a weight matrix that is too large to store in the RAM circuitry 109 in its entirety, into a number of tiles each small enough to store in the on-chip memory 108. Each tile of weights can then be iteratively applied to the input vector in either the recurrent or non-recurrent manner to generate an output vector. The tiling described herein can be applied to all weight matrices W_{#} and U_{#} for the equations (1)-(4) above. The number of tiles into which the weight matrix is divided for transfer to the RAM circuitry 109 can be determined based on the size of the weight matrices and the size of the RAM circuitry 109. In some embodiments, a number of rows of the weight matrices W_{#} or U_{#} processed or transferred in each tile can be adapted while maintaining the number of tiles needed or number of iterations used to transfer the weight matrices, described further below. The tiling performed herein provides improvements by transferring the weight matrices from the memory circuitry 104 to the on-chip memory 108 without invoking pruning or quantization. In some embodiments, the tiling based on available resources, as described herein, may be integrated with pruning or quantization to further improve communication latencies.

In some embodiments, a budget of available RAMs in the RAM circuitry 109 is identified, for example, based on input from a user, a determination of available resources (such as available RAMs), and the like. Based on this budget of available RAMs, a number of RAMs used to perform non-MVM operations in the LSTM is calculated, with the remaining number of RAMs corresponding to the RAMs available for MVM operations. Based on this number of remaining RAMs, a number of iterations to compute each MVM operation is calculated, the number of iterations denoted as Iₙ. Additionally, a minimum number of rows of each weight matrix that can be copied from the memory circuitry 104 per each iteration is calculated, denoted by Nₚ. In a last iteration, remaining rows of the weight matrix, the last rows denoted by Nᵣ are copied from the memory circuitry 104. Since data from four consecutive rows of the weight matrix are being transferred for every data cycle, both Nₚ and Nᵣ are multiples of four, or padded with zeros such that they are multiples of four. In embodiments of different sized RAMs of the RAM circuitry 109, HP I/O 110, and the like, the N, Nₚ, and Nᵣ values are multiples of another number.

The following equation gives the relationship between N, Nₚ, Nᵣ and Iₙ:

N=Nₚ×(Iₙ−1)+Nᵣ (9)

Since only Nₚ or Nᵣ rows are transferred from the memory circuitry 104 in any iteration, the weight matrix can be transposed into the column major order after tiling and zero padding, as shown in the inset 220 of FIG. 2. Each transposed matrix will be transferred to the RAM circuitry 109 in each iteration of MVM operation.

As an example applying equation (9), the weight matrix in the memory circuitry 104 includes 800 rows (N=800) and there are 196 RAMs available in the on-chip memory. The number of iterations, Iₙ, is calculated based on dividing N by the available RAMS and rounding up to the nearest integer value. Thus, where N=800 and there are 196 RAMs available, Iₙ is 5 (800/196=4.08, rounded up to 5). Assuming full usage of the 196 RAMs, 5 iterations are needed, and as applied to equation (9), when N is 800, Nₚ is 196, Iₙ is 5, and Nᵣ is 16. In, the last iteration, when using the full 196 RAMs for the first four iterations, 16 rows are transferred. This may result in 180 RAMs being “idle” or wasted during the last iteration.

However, in some instances, instead of using all available RAMs for the iterations, a minimum number of RAMs is used to copy a minimum number of rows of the weight matrix into the on-chip memory per iteration without increasing the number of iterations, which leaves a number RAMs available for other processing in parallel with the transfer of the weight matrix rows. For example, 100% usage of the RAMs in the first 4 iterations left 16 rows for the last iteration, as described above. Instead of full usage of the RAMs, equation (9) can be used to identify a minimum number of rows that can be transferred per iteration (in 5 iterations calculated above) by setting Np and Nᵣ equal to each other and solving for Nₚ/Nᵣ. For example, 800=Nₚ×(5−1)+Nₚ. Solving for Nₚ, Nₚ=160. Thus, without increasing the number of iterations, and by instead using the minimum 160 RAMs (minimum that maintains 5 iterations), the 5 iterations of 160 RAMs leaves 36 RAMs available for other uses, which maintains the communications latency and efficiency but can improve overall efficiency by enabling other processing as needed. The number of MVM operations applied may match the minimum number of iterations by maximizing the number of MAC operations occurring in parallel, based on the user mentioned budget of resources.

The padded weight matrix 222 is then tiled into the number of tiles 221a-221c (as Iₙ calculated above) of a padded and tiled weight matrix 224. As shown, the padding in the horizontal direction exists in each of the three tiles 221a-221c, while the padding in the vertical direction exists in only the tile 221c. The three tiles 221a-221c shown are exemplary, where any other number of tiles may be used based on the calculated number of iterations, Iₙ.

As described above, each row in the padded and tiled weight matrix 224 is transferred by rows into a separate RAM block of the RAM circuitry 109. For the transfer to the RAM block, the weight matrix weights are grouped in fours values to utilize the full 128-bit bandwidth available for the interconnect 206, where each of the four values comes from a different row. The tiles 221a-221c of the padded and tiled weight matrix 224 is transposed, placing the three tiles in the arrangement shown in transposed blocks 226a-226c such that the weight matrix weights are stored in the same order in continuous locations in the memory circuitry 104. In some embodiments, weight rearrangement depends on available HP I/O ports and available memory elements. Because information regarding the HP I/O ports and memory elements is known based on IC specifications, for example, from a targeted FPGA. Thus, offline rearrangement of the weights can be performed. In the example embodiments described herein, each tile is stored in the memory circuitry 104 in the column major order described above. As such, for the example embodiments herein, the data in four consecutive address locations of the memory circuitry 104 comprise the data from four consecutive rows of the weight matrix 224, including any padding.

Once the weight matrix 202 is tiled, padded, and transposed, the transposed blocks 226a-226c are then loaded into an interconnect 206 of the HP I/O 110 port. Where the HP I/O 110 port has the bandwidth of 128-bits, the transposed blocks 226a-226c may be loaded into the interconnect 206 four elements at a time. Different bandwidths result in different numbers of elements. The interconnect 206 may link the memory circuitry 104 with the on-chip memory 108. The on-chip memory 108 may receive the four weight values as 128-bit variables and unpack them at block 210. The 32-bit length unpacked weight values are then stored in individual RAMs 214. By generating the transposed blocks 226a-226c, the speed of the data transfer from the memory circuitry 104 to the on-chip memory 108 and the RAM circuitry 109 is improved as compared to transferring the data without transposing the weights in the weight matrices 202.

The equations (1)-(4) above include eight total MVM operations. Four MVM operations U_{#}*hₜ₋₁ depend recursively on an output of a previous LSTM cell, while the other four MVM operations W_{#}*xₜ depend only on a current state input vector. The eight MVM operations can be separated into two groups by, for example, the processor circuitry 103 of the PS 102: 1) four non-recurrent MVM operations, W_{#}*xₜ and 2) four recurrent MVM operations, U_{#}*hₜ₋₁. Because the non-recurrent MVM operations do not have any dependency on previous cell outputs, if the weights from the corresponding weight matrices W_{#} are loaded into the on-chip memory 108, then the weights can be multiplied by (e.g., applied to) each of the T input vectors before performing the remaining operations of each cell in the LSTM layer. This eliminates reloading of the weights from the W_{#} weight matrices, even if the available on-chip memory 108 is unable to store all of the W_{#} weight matrices at a time. The processing of the four non-recurrent MVM operations can occur sequentially or in parallel.

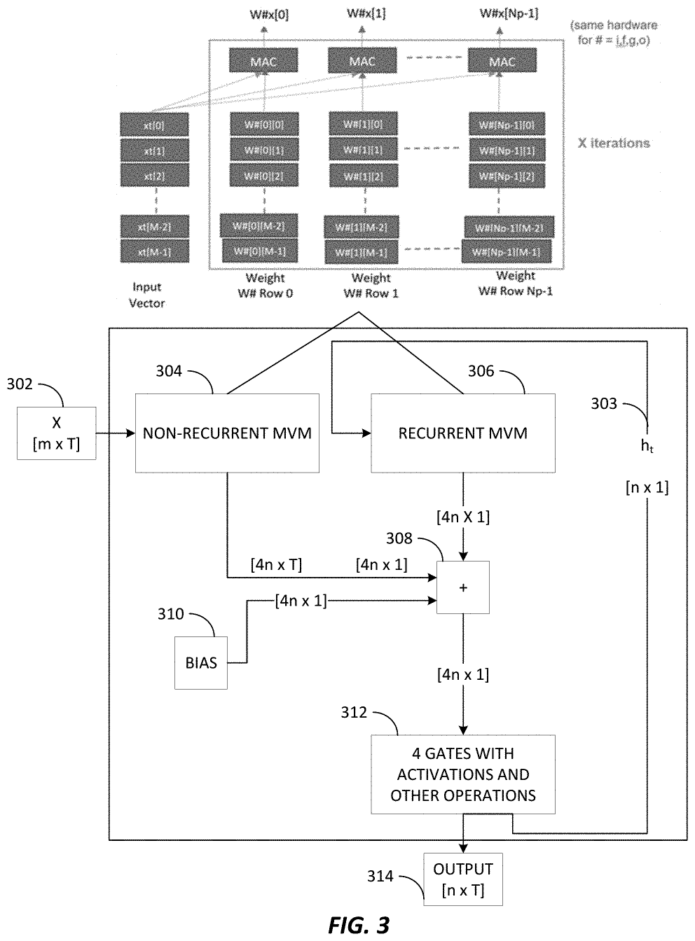

Once the non-recurrent MVM operations for all the LSTM cells are completed, the same hardware can be used to store the U_{#} weight matrices and perform the recurrent MVM operations. However, unlike the non-recurrent MVM operations, the recurrent MVM operations in current LSTM cell cannot be performed until a previous cell output is available. Accordingly, the weights from the U_{#} weight matrices are reloaded for each input vector when the on-chip memory 108 is insufficient to store all of the weights of the U_{#} weight matrices. FIG. 3 provides details of a hardware block that performs such processing of the MVM operations.

FIG. 3 depicts an example block diagram of a matrix multiplication circuitry 300 configured to apply weight matrices W_{#} and U_{#} to non-recurrent input vectors 302 (xₜ) and recurrent input vectors 303 (hₜ) (also referred to herein as hidden state vectors), respectively, to generate an output vector 314. The recurrent input vectors 303, or hidden state vectors, may represent a memory of the neural network, storing or holding information from, for example, a previous iteration, and so forth. The non-recurrent input vectors 302, as shown, may be received as a matrix that consists of current state input vectors xₜ (1≤t≤T) as columns, each input vector having a size (m×1), giving the matrix a size of m×T.

For example, after the processor circuitry 103 separates the eight MVM operations into the four recurrent MVM operations and the four non-recurrent MVM operations, the circuitry 300 can be used to perform the MVM operations, as described below.

The circuitry 300 is configured to perform the calculations associated with equations (1)-(4) introduced above. Thus, the circuitry 300 performs the eight matrix multiplications of equations (1)-(4). To perform such multiplications, the circuitry 300 comprises a non-recurrent block 304 that processes the non-recurrent MVM operations and a recurrent block 306 that processes the recurrent MVM operations.

Performing the MVM operations involves connecting every weight row and input vector copied into RAMs (for example, of the RAM circuitry 109) to MAC blocks, a representation of which is shown as MAC blocks 350. With Nₚ weight rows from each W_{#} matrix or U_{#} matrix loaded into the RAMs, there are a total of 4×Nₚ number of MAC units working in parallel, 1×Nₚ for each weight matrix W_{#} or U. The MAC blocks 350 perform various operations. The MAC blocks read elements from the non-recurrent input vectors 302 and weights from the loaded weight matrix rows. The elements from the non-recurrent input vectors 302 and the weights are read out in first in first out (FIFO) manner. The MAC blocks 350 then multiply the elements from the non-recurrent input vectors 302 with the corresponding weights to produce products. The MAC blocks 350 then read previous results, for example, from an internal buffer, accumulate the products with the previous results, and store the accumulated results, for example, back into the internal buffer. The internal buffer may be reset before each MVM operation, and the MAC operations are repeated for both the non-recurrent MVM operations and the recurrent MVM operations.

The non-recurrent block 304 employs the MAC blocks 350 to perform the MAC computations. As shown, each row of weights from the weight matrices is handled by a different MAC block as different rows of weights are stored in different RAMs. Thus, the non-recurrent block 304 performs computations associated with applying the weight matrices W_{#} to the non-recurrent input vectors 302. The recurrent block 306, using the same hardware as the non-recurrent block 304, performs similar MAC computations via the MAC blocks 350 to obtain corresponding vector products of the recurrent input vectors 302 and the corresponding weights from the loaded weight matrix rows before it accumulates the generated results. Thus, the recurrent block 306 performs computations associated with applying the corresponding weights to the recurrent input vectors 303.

The processing by the non-recurrent block 304 is not reliant on any previous processing to complete the corresponding computation, such that weights can be applied to input vectors independent of application of the weights to other input vectors. Therefore, for a particular calculation according to the equations (1)-(4) above, the non-recurrent block 304 can load weights from the weight matrix W_{#} (or tile of the weight matrix) for the corresponding equation once and then apply the loaded weights to each input vector of the non-recurrent input vectors 302. When the weight matrix is tiled (for example, when the weight matrix is too large to be transferred in a single transaction), then this process can be repeated for a subsequent tile until the entire weight matrix is applied to each of the non-recurrent input vectors 302. For example, when a weight matrix is tiled into two tiles (tile A and tile B), each tile is loaded into the RAM circuitry 109 one at a time, as described with reference to FIG. 2. For example, the tile A can be loaded into the RAM 109 and multiplied with all non-recurrent input vectors xₜ because each non-recurrent input vector is available for processing when the weight tile A is loaded into the RAM 109. The next tile B can then be loaded into the RAM 109 and multiplied with the non-recurrent input vectors xₜ. Thus, each tile of the weight matrix need only be loaded into the RAM 109 once to be applied to all of the non-recurrent input vectors 302. The processing of each non-recurrent input vector 302 and the corresponding weight matrices W_{#} by the non-recurrent block 304 generates output vectors of size 4n×T and 4n×1. For the block 304, the output vectors may form a matrix that is 4n×T size. From this matrix, one vector of size 4n×1 will be read by a block 308 in T iterations. Blocks 306, 308 and 312, described herein, repeat their operations for the T iterations.

The recurrent input vectors 303, on the other hand, are generally reliant or based on the processing of the previous input vectors, as indicated by the loop of the recurrent input vectors 303 from the block 312 to the recurrent block 306. Because the recurrent input vectors 303 are reliant upon the previous recurrent input vectors, application or multiplication of tiles of the weights to the corresponding input vectors cannot be performed independently of each other. Instead, for the weight matrix tiled into tiles A and B, the tile A is loaded and multiplied with the first recurrent input vector because subsequent recurrent input vectors are dependent on the first recurrent input vector. Accordingly, the tile B is loaded and multiplied with the first recurrent input vector. For each subsequent recurrent input vector, the tile A is loaded and multiplied and the tile B is loaded and multiplied. Thus, there are two tiles reloaded for each recurrent input vector. Thus, when a weight matrix is tiled (e.g., when the RAM circuitry 109 is not large enough to store the entire weight matrix applied to the recurrent input vectors 303), each tile of weights is consecutively loaded and applied to the corresponding elements of a current recurrent input vector 303 and then reloaded for a subsequent recurrent input vector 303. The recurrent block 306 may generate an output vector of 4n×1.

A tile of the weight matrix W_{#} is then loaded to the on-chip memory 108 of the PL 106 and iteratively multiplied by each of the input vectors from x₁ to x_{T} because all of the input vectors are available. This can be performed for each individual tile of the weight matrix W_{#} until all of the weight matrix W_{#} tiles are multiplied by all of the input vectors x₁ to x_{T}. Each tile of the weight matrix W_{#} is only loaded into the on-chip memory 108 once and then overwritten only after being multiplied by all of the input vectors x₁ to x_{T}. In this manner, the MVM operations for the weight matrix W_{#} can be completed because no overwriting of data occurs.

However, the same cannot be said for the weight matrix U_{#}. Specifically, because the hidden state vector hₜ is the output of the current LSTM cell, subsequent hidden state vectors hₜ₊₁ are only available after completing all mathematical operations on the current LSTM cell. Thus, performing the MVM operations for the weight matrix U_{#} by tiling the weight matrix U_{#} may involve reloading the different tiles of the weight matrix U_{#} for each hidden state vector, which results in the data communication latency between the PS 102 and the PL 106 introduced above, specifically because data is loaded from the memory circuitry 104 to the on-chip memory 108 repeatedly.

The output vectors from the non-recurrent block 304 are added to the output vectors generated by the recurrent block 306 at block 308, where a bias vector 310 is also added to the outputs of the recurrent block 306 and the non-recurrent block 304. The bias vector can comprise a plurality of vectors, each having a size of (n×1). For example, bias vectors bi, bf, bo, and bg, each of size (n×1), collectively form the bias vector 310 of size 4n×1. This enables the circuitry 300 to generate an output for each of the equations (1)-(4) above.

Embodiments of pruning or quantizing the weight matrices may result in reduced accuracy.

The systems, methods, and apparatuses described herein implement tiling of the weight matrices based on available or budgeted resources to minimize a number of tiles created from the weight matrices for a given hardware accelerator. This can reduce a number of iterations needed to complete all MVM operations as compared to a fixed tile size where additional resources are available and wasted, thereby reducing inefficiencies and accelerating LSTM operation implemented by the hardware accelerator.

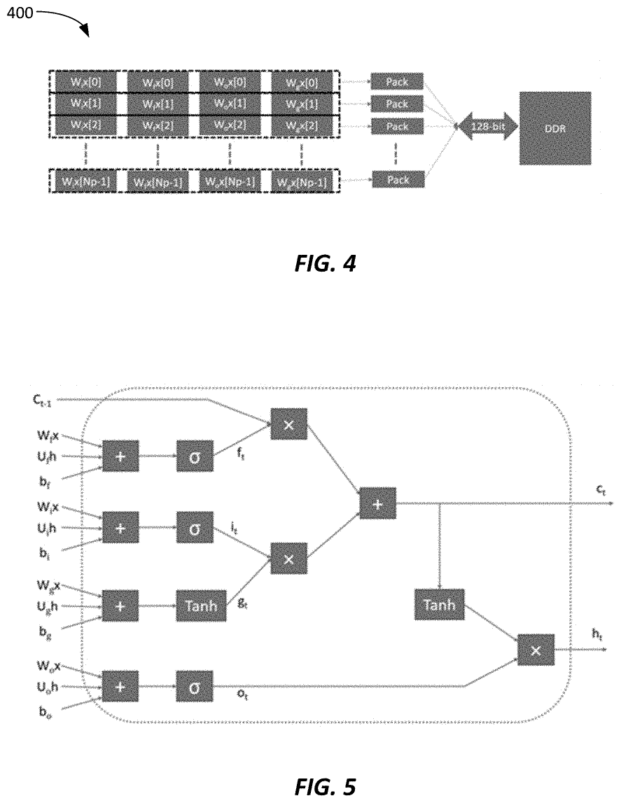

As described above, the four (recurrent or non-recurrent) MVM operations are computed in parallel. Thus, if Nₚ or Nᵣ rows from each corresponding weight matrix are loaded into the RAM circuitry 109, then Nₚ or Nᵣ corresponding outputs of each MVM operation are generated in every iteration. Once the weights of the non-recurrent MVM operations are loaded into the RAM circuitry 109, they are multiplied with all the T input vectors by loading the input vectors one after the other. Four partial output vectors, each of size Nₚ×1 or Nᵣ×1, are generated for each input vector in an iteration and transferred to the memory circuitry 104, accounting for offsets of address location and the like. FIG. 4 below provides an example of how the output vectors may be transferred from the RAM circuitry 109 to the memory circuitry 104.

FIG. 4 depicts an exemplary block diagram 400 of depicting the transfer of output vectors from a RAM circuitry 409, corresponding to the RAM circuitry 109 of FIG. 1, to a memory circuitry 404, corresponding to the memory circuitry 104, via interconnects, corresponding to the interconnects 206 of FIG. 2. As noted because, the four recurrent or non-recurrent MVM operations are computed in parallel, there are four output vectors (or partial output vectors) generated at once. Thus, when transferring the output vectors, or partial output vectors, from the RAM 409, the output vectors corresponding to the four gates (i,f,o,g) are packed into a 128-bit structure of the HP I/O 110 port and corresponding interface for transfer to the memory circuitry 404. Therefore, the non-recurrent MVM outputs corresponding to all four gates will occupy four consecutive memory locations of the memory circuitry 404. After completion of all the iterations of the non-recurrent MVM operations, a whole output matrix of size 4N×T will be available in memory circuitry 404. The last (N−n) elements in each output vector may be zeros, which are corresponding outputs of zero padded rows from the corresponding weight matrices, described above. Once all the non-recurrent MVM operations are completed, the same hardware is used to perform the recurrent MVM operations, as described above. Since a size of the recurrent input vectors hₜ₋₁ is N×1, the corresponding MAC operations repeat for N times to complete each MVM operation, as described above. Because the computations cannot proceed for recurrent MVM operation in a next cell until computations for a current cell are completed, the whole U_{#} weight matrix must be multiplied with the loaded input vector. If the available RAM has sufficient size to store all four U_{#} weight matrices at once, then the weights do not need to be re-loaded for each LSTM cell. If the RAM does not have sufficient size and the weights are loaded in tiles or iterations (for example, Nₚ or Nᵣ rows from each U_{#} weight matrix are loaded at once), then the weights stored in the RAM are replaced with next Nₚ or Nᵣ rows in each iteration. Therefore, the weights must be reloaded for every new input vector for each LSTM cell.

As described above, after completion of the recurrent and non-recurrent MVM operations are completed, the corresponding output vectors are added with a bias vector. In some embodiments, the bias vector is rearranged, padded with zeros, and stored into the memory circuitry 404. Because of the rearrangement, elements corresponding to the four gates (i,f,o,g) occupy four continuous locations of the memory circuitry 404. The bias vector is then transferred from the memory circuitry 404 as a 128-bit structure through an HP I/O port to the RAM circuitry 109, where each structure is unpacked and stored into four different RAMs. Each RAM block stores N elements of the bias vector corresponding to each gate.

FIG. 5 depicts an LSTM architecture that performs operations described herein. For example, FIG. 5 shows non-recurrent and recurrent outputs generated in FIG. 3 are added with bias vectors using four parallel adders. Remaining operations in FIG. 5 including pipelining between each operation, correspond to the equations (5) and (6) above. The operations may be applied to every element of the output vectors from the MVM operations of FIG. 3. Two vectors having a size N×1, cₜ and hₜ, are generated as final outputs of the operations performed by the LSTM architecture, in which the last (N−n) elements are zeros, corresponding to zero padding of the weights, etc. Similar hardware can be used for computing both forward and backward LSTM layers. For the forward layer, the input vectors xₜ are loaded into PL from t=1 to t=T, whereas the input vectors are loaded from t=T to t=1 for the backward layer.

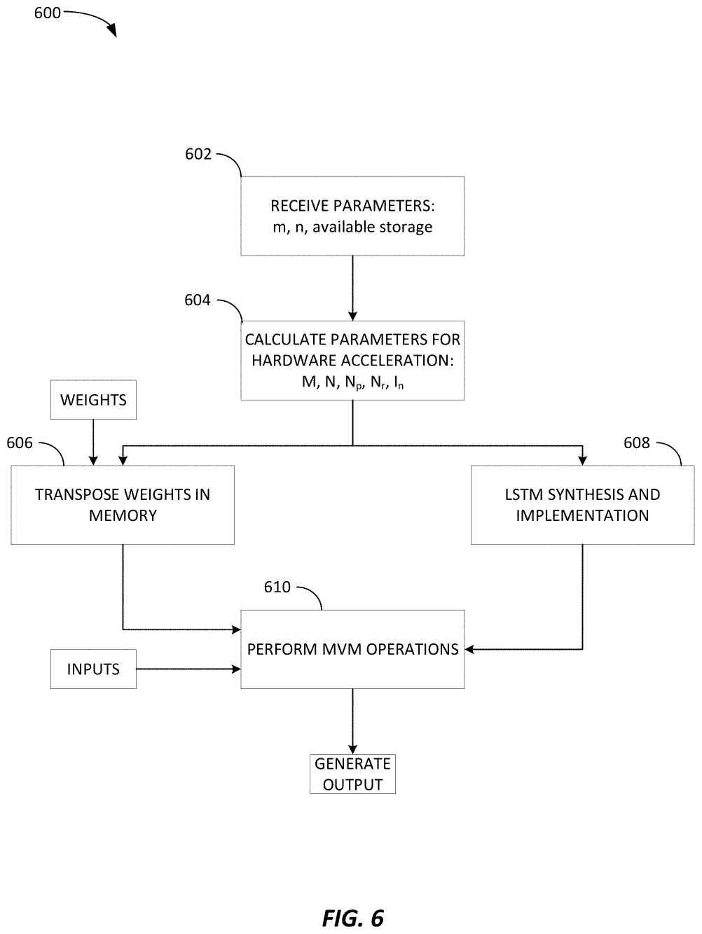

FIG. 6 depicts a flowchart for operations 600 that calculate output vectors for MVM operations using an IC, such as an FPGA, when applying optimizations described herein. At block 602, parameters, such as values for m and n and available RAMs are obtained, for example, as input from a user or scanning of a memory circuitry storing weight matrices and on-chip memories. For example, an end user can identify resource availability for the PL 106 and a script or algorithm can be run by one of processor circuitry 103 or DSP 107 to identify one or more of the tiles/iterations, rows to be transferred in each iteration, and the like. In some embodiments, the hardware architecture described herein is adjustable based on the identified resource availability.

At block 604, values for M, N, Nₚ and Nᵣ are computed to minimizing a number of iterations required to compute each MVM operation according to, for example, equations (1)-(4) and (9). The values for M, N, Nₚ and Nᵣ are also used to rearrange weight matrices and bias vectors that are extracted or received from a trained neural network model. In some embodiments, the M, N, Nₚ and Nᵣ values are calculated offline (for example, without reference to specifics of the FPGA) and stored in a file.

These values, whether calculated offline or online, can also be used to pad and transpose input weight matrices in a memory circuitry at block 606 for transfer to on-chip memory of the FPGA for MVM operations. In some embodiments, the padding and transposing of the weights in the memory is also performed offline. The transposed weights may be stored in a memory circuit, such as the memory circuit 104. Alternatively, a PS of the FPGA, such as the PS 102, may perform the blocks 604 and 606. At block 608, the values from block 604 are synthesized and implemented as a LSTM. In certain instances, different use cases or different programs may employ different m, n, and available storage parameters, or such parameters may change during use (for example, current conditions may change available storage parameters, or a particular model being applied may have different m and/or n values. In some embodiments, the synthesis and implementation of the LSTM at block 608 is performed by a software tool, which may take a software program, such as an ML model being applied, and converts the program into a bitstream, that is utilized by an FPGA device, which may perform the operations of a block 610. For example, the tool converts, at block 608, code for the program to a binary file that includes all details of the processing to perform at the block 610 and that is used to program or applied to the FPGA device that performs the processing of block 610. Accordingly, as values of m, n, or available storage change, the aspects of the program change and the FPGA device needs to be reprogrammed accordingly, which is performed at the block 608. Block 610 then uses the rearranged weights from block 606 and input vectors to perform MVM operations, as described above, and generate corresponding output vectors.

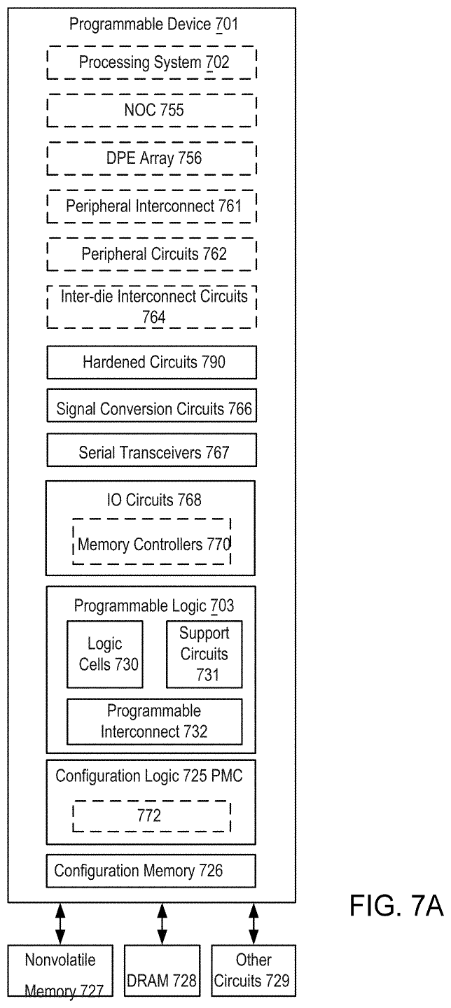

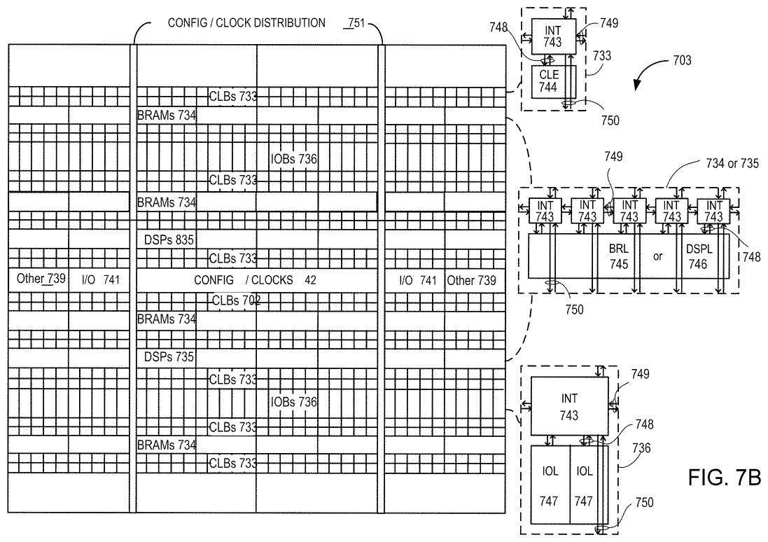

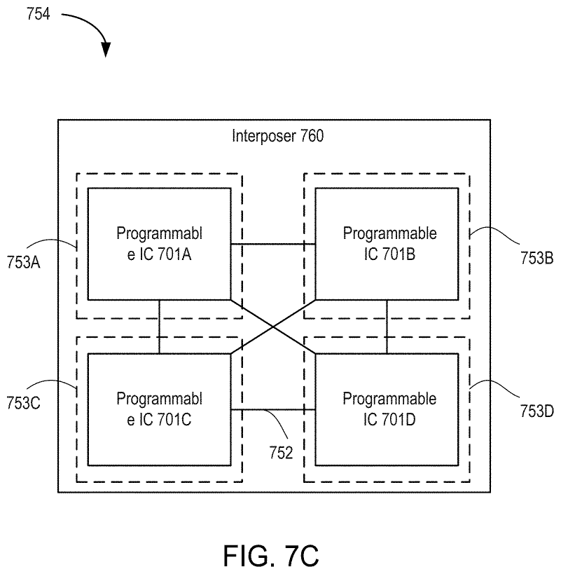

FIG. 7A is a block diagram depicting a programmable device 701 according to an example. The programmable device 701 includes programmable logic (PL) 703 (also referred to as a programmable fabric), which corresponds to the PL 106 of FIG. 1, input/output (IO) circuitries 768, serial transceivers 767, signal conversion circuitries 766, hardened circuitries 790, configuration logic 725, and configuration memory 726. The programmable device 701 can be coupled to external circuitries, such as nonvolatile memory 727, dynamic random access memory (DRAM) 728, and other circuitries 729. In various examples, the programmable device 701 further includes a processing system (PS) 702, corresponding to the PS 102 of FIG. 1, a network-on-chip (NOC) 755, a data processing engine (DPE) array 756, peripheral interconnect 761, peripheral circuitries 762, and inter-die interconnect circuitries 764.

The PL 703 includes logic cells 730, support circuitries 731, and programmable interconnect 732. The logic cells 730 include circuitries that can be configured to implement general logic functions of a plurality of inputs. The support circuitries 731 include dedicated circuitries, such as digital signal processors, memories, and the like. The logic cells and the support circuitries 731 can be interconnected using the programmable interconnect 732. Information for programming the logic cells 730, for setting parameters of the support circuitries 731, and for programming the programmable interconnect 732 is stored in the configuration memory 726 by the configuration logic 725. The configuration logic 725 can obtain the configuration data from the nonvolatile memory 727 or any other source (e.g., the DRAM 728 or from the other circuitries 729). In some examples, the configuration logic 725 includes a platform management controller (PMC) 772. The PMC 772 is configured to boot and configure the subsystems of the programmable device 701, such as the PL 703, the PS 702, the NOC 755, the DPE array 756, the signal conversion circuitries 766, the hardened circuitries 790, and the like.

The IO circuitries 768 provide an external interface for the subsystems of the programmable device 701, such as the PL 703, the PS 702, and the like. In some examples, the IO circuitries 768 include memory controllers 770 configured to interface external memories (e.g., the DRAM 728). Other connectivity circuitries can include the peripheral interconnect 761, the peripheral circuitries 762, and the inter-die interconnect circuitries 764. The peripheral interconnect 761 includes bus interface circuitries, such as peripheral component interconnect express (PCIe) circuitries and the like. The peripheral circuitries 762 include universal serial bus (USB) ports, Ethernet ports, universal asynchronous transceiver (UART) ports, serial peripheral interface (SPI) ports, general purpose 10 (GPIO) ports, serial advanced technology attachment (SATA) ports, and the like. The inter-die interconnect circuitries 764 include circuitries configured to interface like inter-die interconnect circuitries in other programmable device(s) (e.g., for when the programmable device 701 is one die in a multi-die integrated circuit package). The serial transceivers 767 include high-speed transmit/receive circuitries configured to provide an external 10 interface for the programmable device 701.

The PS 702 can include microprocessor(s), memory, support circuitries, IO circuitries, and the like. The NOC 755 is configured to provide for communication between subsystems of the programmable device 701, such as between the PS 702, the PL 703, the hardened circuitries 790, and the DPE array 756. The DPE array 756 can include an array of DPE's configured to perform data processing, such as an array of vector processors. The signal conversion circuitries 766 include analog-to-digital converters (ADCs) and digital-to-analog converters (DACs).

The hardened circuitries 790 comprise circuitries with predetermined functionality. A given hardened circuitry 790 can include one or more predetermined functions. Example hardened circuitries 790 include filters, mixers, sample-rate converters, transforms circuitries, and the like. A hardened circuitry 790 can be programmable to configure specific predetermined functionalities or select among predetermined functionalities. However, in contrast to a circuitry in the PL 703, a hardened circuitry 790 cannot be configured or reconfigured with different functionality. For example, a hardened circuitry 790 can include a filter having two predetermined and selectable functionalities. A third functionality cannot be added to the hardened circuitry 790, nor can one of the two functionalities be removed from the hardened circuitry 790. In contrast, a filter configured in the PL 703 can be reconfigured to add one more additional functionalities or to remove one or more functionalities. Further, a filter configured in the PL 703 can be removed entirely and replaced with another circuitry. In contrast, a hardened circuitry 790 cannot be removed from the programmable device 701 (but can be unused if desired).

FIG. 7B illustrates a field programmable gate array (FPGA) implementation of the PL 703 according to an example. The PL 703 shown in FIG. 7B can be used in any example of the programmable devices described herein. The PL 703 includes a large number of different programmable tiles including configurable logic blocks (“CLBs”) 733, random access memory blocks (“BRAMs”) 734, input/output blocks (“IOBs”) 736, configuration and clocking logic (“CONFIG/CLOCKS”) 742, digital signal processing blocks (“DSPs”) 735, specialized input/output blocks (“I/O”) 741 (e.g., configuration ports and clock ports), and other programmable logic 739 such as digital clock managers, analog-to-digital converters, system monitoring logic, and so forth.

In some PLs 703, each programmable tile can include at least one programmable interconnect element (“INT”) 743 having connections to input and output terminals 748 of a programmable logic element within the same tile, as shown by examples included at the top of FIG. 7B. Each programmable interconnect element 743 can also include connections to interconnect segments 749 of adjacent programmable interconnect element(s) in the same tile or other tile(s). Each programmable interconnect element 743 can also include connections to interconnect segments 750 of general routing resources between logic blocks (not shown). The general routing resources can include routing channels between logic blocks (not shown) comprising tracks of interconnect segments (e.g., interconnect segments 750) and switch blocks (not shown) for connecting interconnect segments. The interconnect segments of the general routing resources (e.g., interconnect segments 750) can span one or more logic blocks. The programmable interconnect elements 743 taken together with the general routing resources implement a programmable interconnect structure (“programmable interconnect”) for the illustrated PL.

In an example implementation, a CLB 733 can include a configurable logic element (“CLE”) 744 that can be programmed to implement user logic plus a single programmable interconnect element (“INT”) 743. A BRAM 734 can include a BRAM logic element (“BRL”) 745 in addition to one or more programmable interconnect elements. Typically, the number of interconnect elements included in a tile depends on the height of the tile. In the pictured example, a BRAM tile has the same height as five CLBs, but other numbers (e.g., four) can also be used. In some embodiments, the BRAM 734 may be used to implement the RAM circuitry 109. A DSP tile 735 can include a DSP logic element (“DSPL”) 746 in addition to an appropriate number of programmable interconnect elements. An 10B 736 can include, for example, two instances of an input/output logic element (“IOL”) 747 in addition to one instance of the programmable interconnect element 743. As will be clear to those of skill in the art, the actual I/O pads connected, for example, to the I/O logic element 747 typically are not confined to the area of the input/output logic element 747.

In the pictured example, a horizontal area near the center of the die (shown in FIG. 7B) is used for configuration, clock, and other control logic. Vertical columns 751 extending from this horizontal area or column are used to distribute the clocks and configuration signals across the breadth of the PL.

Some PLs utilizing the architecture illustrated in FIG. 7B include additional logic blocks that disrupt the regular columnar structure making up a large part of the PL. The additional logic blocks can be programmable blocks and/or dedicated logic.

Note that FIG. 7B is intended to illustrate only an exemplary PL architecture. For example, the numbers of logic blocks in a row, the relative width of the rows, the number and order of rows, the types of logic blocks included in the rows, the relative sizes of the logic blocks, and the interconnect/logic implementations included at the top of FIG. 7B are purely exemplary. For example, in an actual PL more than one adjacent row of CLBs is typically included wherever the CLBs appear, to facilitate the efficient implementation of user logic, but the number of adjacent CLB rows varies with the overall size of the PL.

FIG. 7C is a block diagram depicting a multi-die programmable device 754 according to an example. The multi-die programmable device 754 includes a plurality of programmable devices 701, e.g., programmable devices 701A, 701B, 701C, and 701D. In an example, each programmable device 701 is an IC die disposed on an interposer 760. Each programmable device 701 comprises a super logic region (SLR) 753 of the programmable device 754, e.g., SLRs 753A, 753B, 753C, and 753D. The programmable devices 701 are interconnected through conductors on the interposer 760 (referred to as super long lines (SLLs) 52) and inter-die interconnect circuitries 764 disposed within each of the programmable devices 701.

The LSTM architecture described herein may be flexible and can be implemented for wide range of FPGAs with any values m and n. In some embodiments, the hardware accelerator described herein as applying the LSTM processing can be extended to Gated Recurrent Units (GRUs). In some embodiments, one or more of the optimizations described herein can be utilized in any network that has or employs recurrence (feedback) dependency.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or apparatus, and the like. Accordingly, aspects may take the form of an entirely hardware embodiment or a combination of hardware products or an embodiment combining hardware aspects with corresponding programming that may all generally be referred to herein as a “circuitry” or “system.” Furthermore, certain aspects, such as programmable logic blocks, lookup tables (LUTs), and the like, may take the form of hardware components that can be controlled using corresponding programming.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations or programming for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and apparatuses according to various examples of the present invention. In this regard, each block in the flowchart or block diagrams may represent a circuitry, programming for such circuitry, or portion of instructions for such circuitry, which comprises one or more executable instructions for controlling or programming the circuitry to perform the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A method of accelerating matrix vector multiplication (MVM), the method comprising:
creating a number of tiles for each weight matrix of a plurality of weight matrices based on a size of the weight matrix and an amount of on-chip memory available, the plurality of weight matrices comprising a set of recurrent weight matrices and a set of non-recurrent weight matrices;
for each non-recurrent weight matrix of the set of non-recurrent weight matrices, processing each tile of the number of tiles of the non-recurrent weight matrix based on:
multiplying each tile of the number of tiles for the non-recurrent weight matrix by each input vector of a set of non-recurrent input vectors based on loading the tile into an on-chip memory, and
applying the tile to each input vector of the set of non-recurrent input vectors before loading a subsequent tile of the number of tiles;
for each recurrent weight matrix of the set of recurrent weight matrices, processing each tile of the number of tiles of the recurrent weight matrix based on:
multiplying each recurrent input vector of a set of recurrent input vectors by each tile of the number of tiles for the recurrent weight matrix based on sequentially loading the tile into the on-chip memory, and
sequentially applying the tile to a first recurrent input vector of the set of recurrent input vectors before sequentially loading and applying the tile to a subsequent recurrent input vector of the set of recurrent input vectors; and
generating an output based on the processing of the tiles of the set of non-recurrent weight matrices and the processing of the tiles of the set of recurrent weight matrices.

2. The method of claim 1, further comprising receiving the amount of on-chip memory available from an end user with the size of the weight matrix.

3. The method of claim 1, further comprising zero padding the plurality of weight matrices in a memory circuitry to make a number of rows of the plurality of weight matrices evenly divisible by a ratio of a bit width of a port connecting the memory circuitry to the on-chip memory and a weight precision of the plurality of weight matrices.

4. The method of claim 1, further comprising calculating, based on a number of rows of the plurality of weight matrices and the amount of on-chip memory available, a minimum number of rows in the amount of on-chip memory available, for transferring the number of rows of the plurality of weight matrices in a number of iterations defined by dividing the number of rows of the plurality of weight matrices by the amount of on-chip memory available, in rows.

5. The method of claim 1, wherein the plurality of weight matrices comprise a plurality of weights having a precision of one of int16, int8, or float32.

6. The method of claim 1, wherein generating an output based on the processing of the tiles of the set of non-recurrent weight matrices and the processing of the tiles of the set of recurrent weight matrices comprises summing a recurrent matrix vector multiplication (MVM) output vector with a corresponding non-recurrent MVM output vector and a bias vector.

7. The method of claim 1, further comprising:
rearranging the number of tiles for each weight matrix in a memory circuitry storing the plurality of weight matrices into column major order; and
transferring the number of tiles for each weight matrix from the memory circuitry to the on-chip memory.

8. An integrated circuitry, comprising:
a processing system comprising a processing circuitry and a memory circuitry, the processing system configured to create a number of tiles for each weight matrix of a plurality of weight matrices based on a size of the weight matrix and an amount of on-chip memory available, the plurality of weight matrices comprises a set of recurrent weight matrices and a set of non-recurrent weight matrices; and
a programmable logic comprising a signal processor and an on-chip memory circuitry, the programmable logic configured to:
for each non-recurrent weight matrix, process each tile of the number of tiles of the non-recurrent weight matrix based on:
multiplication of each tile of the number of tiles for the non-recurrent weight matrix by each input vector of a set of non-recurrent input vectors based on loading the tile into the on-chip memory, and
application of the tile to each input vector of the set of non-recurrent input vectors before loading a subsequent tile of the number of tiles; and
for each recurrent weight matrix, process each tile of the number of tiles of the recurrent weight matrix based on:
multiplication each recurrent input vector of a set of recurrent input vectors by each tile of the number of tiles for the recurrent weight matrix based on sequentially loading each tile into the on-chip memory and sequentially applying each tile to a first recurrent input vector of the set of recurrent input vectors before sequentially loading, and
application of each tile to a subsequent recurrent input vector of the set of recurrent input vectors; and
generate an output based on the processing of the tiles of the set of non-recurrent weight matrices and the processing of the tiles of the set of recurrent weight matrices.

9. The system of claim 8, wherein the processing system is further configured to receive the amount of on-chip memory available from an end user with the size of the weight matrix.

10. The system of claim 8, wherein the processing system is further configured to zero pad the plurality of weight matrices in a memory circuitry to make a number of rows of the plurality of weight matrices evenly divisible by a ratio of a bit width of a port connecting the memory circuitry to the on-chip memory and a weight precision of the plurality of weight matrices.

11. The system of claim 8, wherein the processing system is further configured to calculate, based on a number of rows of the plurality of weight matrices and the amount of on-chip memory available, a minimum number of rows in the amount of on-chip memory available, for transferring the number of rows of the plurality of weight matrices in a number of iterations defined by dividing the number of rows of the plurality of weight matrices by the amount of on-chip memory available, in rows.

12. The system of claim 8, wherein the plurality of weight matrices comprise a plurality of weights having a precision of one of int16, int8, or float32.

13. The system of claim 8, wherein the processing circuitry is further configured to sum a recurrent MVM output vector with a corresponding non-recurrent MVM output vector and a bias vector as a component of the generated output.

14. The system of claim 8, wherein the processing circuitry is further configured to:
rearrange the number of tiles for each weight matrix in a memory circuitry storing the plurality of weight matrices into column major order; and
transfer the number of tiles for each weight matrix from the memory circuitry to the on-chip memory.

15. A system for accelerating processing by an LSTM architecture, the system comprising:
a first processing circuitry configured to:
receive a plurality of weight matrices from a trained neural network, and
store the plurality of weight matrices in a first memory circuitry; and
a second processing circuitry configured to:
store the plurality of weight matrices in a second memory circuitry, and
generate an output vector based on the plurality of weight matrices and a plurality of input vectors,
wherein:
the first processing circuitry is further configured to:
process each of the plurality of weight matrices for communication to the second processing circuitry, and
divide each weight matrix of the plurality of weight matrices into a number of tiles based on an available resources in the second memory circuitry and a size of the weight matrix, and
the second processing circuitry is further configured to apply each tile of each weight matrix to a corresponding input vector of the plurality of input vectors to generate the output vector.

16. The system of claim 15, wherein the first processing circuitry is further configured to receive the available resources in the second memory circuitry from an end user.

17. The system of claim 15, wherein the first processing circuitry is further configured to pad each of the plurality of weight matrices with zeroes in the first memory circuitry to make a number of rows of the plurality of weight matrices evenly divisible by a ratio of a bit width of a port connecting the first memory circuitry to the second memory circuitry and a weight precision of weight matrices.

18. The system of claim 15, wherein the first processing circuitry is further configured to calculate, based on a number of rows of the plurality of weight matrices and the available resources, a minimum number of rows in the second memory circuitry available for transferring the number of rows of the plurality of weight matrices in a number of iterations defined by dividing the number of rows of the plurality of weight matrices by the available resources, in rows.

19. The system of claim 15, wherein the plurality of weight matrices comprise a plurality of weights having a precision of one of int16, int8, or float32.

20. The system of claim 15, wherein the second processing circuitry is further configured to sum a recurrent MVM output vector with a corresponding non-recurrent MVM output vector and a bias vector as a component of the generated output vector.
